(19) United States
(12) Patent Application Publication
(10) Pub. No.: US 2024/0152800 A1
(43) Pub. Date: May 9, 2024

(54) ELECTRONIC DEVICE AND METHOD FOR DETERMINING SCENARIO DATA OF SELF-DRIVING CAR

(71) Applicant: Industrial Technology Research Institute, Hsinchu (TW)

(72) Inventors: Hsiu-Wei Hsu, Taipei City (TW); Chen-Hui Hu, Miaoli County (TW)

(73) Assignee: Industrial Technology Research Institute, Hsinchu (TW)

(21) Appl. No.: 18/087,840

(22) Filed: Dec. 23, 2022

(30) Foreign Application Priority Data
Nov. 8, 2022 (TW) 111142575

(51) Int. Cl. G06N 20/00

(52) U.S. Cl. CPC G06N 20/00

(57) ABSTRACT

An electronic device and a method for determining scenario data of a self-driving car are provided. The method includes: obtaining training scenario data by using scenario data, a loss function and a self-driving program module; training an encoding module and a decoding module by using the training scenario data, and generating a scenario space by using the trained encoding module; obtaining a monitoring module by using the scenario space; and executing the monitoring module to determine whether current scenario data belongs to an operational design domain by using the current scenario data and the trained encoding module.

### CROSS-REFERENCE TO RELATED APPLICATION

This application claims the priority benefit of Taiwan application serial no. 111142575 filed on Nov. 8, 2022. The entirety of the above-mentioned patent application is hereby incorporated by reference herein and made a part of this specification.

### TECHNICAL FIELD

The disclosure relates to a self-driving car technology, and in particular relates to an electronic device and a method for determining scenario data of a self-driving car.

### BACKGROUND

When a self-driving car is in actual operation, the self-driving car may encounter scenario data known to the self-driving car, or it may encounter scenario data unknown to the self-driving car. Since the unknown scenario data may include a combination of many parameters, it is often difficult for the current self-driving car technology to determine in real time whether the unknown scenario data is safe for the self-driving car. That is, it is difficult to determine in real time whether the self-driving car is suitable for automatic driving under these unknown scenario data.

### SUMMARY

The disclosure provides an electronic device and a method for determining scenario data of a self-driving car, which may improve the safety of the self-driving car in actual operation. The electronic device for determining a scenario data of a self-driving car of the disclosure includes a storage medium and a processor. The storage medium stores an encoding module and a decoding module. The processor is coupled to the storage medium and is configured to perform the following operation. Training scenario data is obtained by using scenario data, a loss function, and a self-driving program module. An encoding module and a decoding module is trained by using the training scenario data, and a scenario space is generated by using a trained encoding module. A monitoring module is obtained by using the scenario space. The monitoring module is executed to determine whether a current scenario data belongs to an operational design domain (ODD) by using the current scenario data and the trained encoding module.

The method for determining a scenario data of the self-driving car of the disclosure is suitable for an electronic device storing an encoding module and a decoding module, and the method includes the following operation. Training scenario data is obtained by using scenario data, a loss function, and a self-driving program module. An encoding module and a decoding module is trained by using the training scenario data, and a scenario space is generated by using a trained encoding module. A monitoring module is obtained by using the scenario space. The monitoring module is executed to determine whether a current scenario data belongs to an operational design domain by using the current scenario data and the trained encoding module.

Based on the above, the electronic device and the method for determining the scenario data of the self-driving car of the disclosure may train the encoding module and the decoding module by using the training scenario data and obtain the monitoring module, and then use the monitoring module to determine whether the current scenario data is safe for the self-driving car in actual operation. In other words, even if the current scenario data is unknown to the self-driving car, the electronic device and the method for determining the scenario data of the self-driving car of the disclosure may determine in real time whether the self-driving car is suitable for automatic driving, thereby improving the safety of the self-driving car in actual operation.

### BRIEF DESCRIPTION OF THE DRAWING

FIG. 1 is a schematic diagram of an electronic device for determining scenario data of a self-driving car according to an embodiment of the disclosure.

FIG. 2 is a flowchart of a method for determining scenario data of a self-driving car according to an embodiment of the disclosure.

FIG. 3 is a schematic diagram of scenario data according to an embodiment of the disclosure.

FIG. 4 is a schematic diagram of generating a scenario space according to an embodiment of the disclosure.

FIG. 5 is a schematic diagram of obtaining loss values of scenario data corresponding to points in the scenario space according to an embodiment of the disclosure.

FIG. 6 is a schematic diagram of a monitoring module obtained based on the loss values according to an embodiment of the disclosure.

FIG. 7 is a flowchart of generating and providing recommended car speed and recommended turn according to an embodiment of the disclosure.

### DETAILED DESCRIPTION OF DISCLOSED EMBODIMENTS

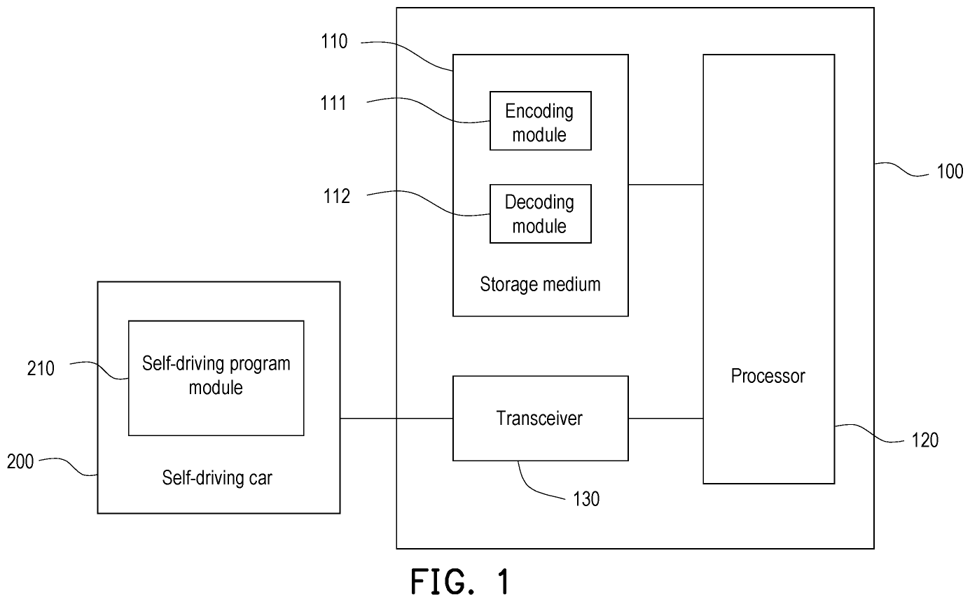

FIG. 1 is a schematic diagram of an electronic device 100 for determining scenario data of a self-driving car according to an embodiment of the disclosure. The electronic device 100 may include a storage medium 110 and a processor 120. In other embodiments, the electronic device 100 may further include a transceiver 130.

The storage medium 110 may include any type of fixed or removable random access memory (RAM), read-only memory (ROM), flash memory, hard disk drive (HDD), solid state drive (SSD), or similar elements, or a combination of the elements thereof configured to store multiple modules or various applications executable by the processor 120. In this embodiment, the storage medium 110 may store multiple modules including an encoding module 111 and a decoding module 112, and the functions of these modules are subsequently described.

The processor 120 may include a central processing unit (CPU), or other programmable general-purpose or special-purpose micro control unit (MCU), microprocessor, digital signal processor (DSP), programmable controller, application specific integrated circuit (ASIC), graphics processing unit (GPU), image signal processor (ISP), image processing unit (IPU), arithmetic logic unit (ALU), complex programmable logic device (CPLD), field programmable gate array (FPGA), or other similar elements, or a combination of the elements thereof. The processor 120 may be coupled to the storage medium 110 and the transceiver 130, and access and execute multiple modules and various application programs stored in the storage medium 110.

The transceiver 130 transmits and receives signals in a wireless or wired manner.

In this embodiment, the electronic device 100 may be communicatively connect to the self-driving car 200 through the transceiver 130. The self-driving car 200 may include a self-driving program module 210.

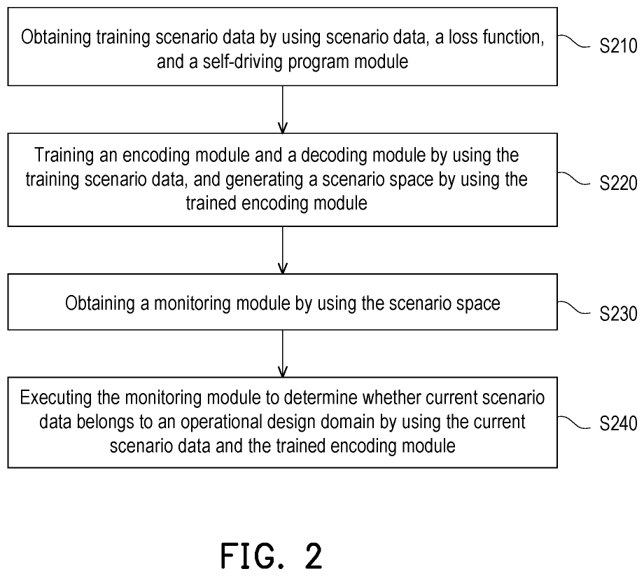

FIG. 2 is a flowchart of a method for determining scenario data of a self-driving car according to an embodiment of the disclosure. Referring to FIG. 1 and FIG. 2 at the same time, the method of this embodiment is suitable for the electronic device 100 in FIG. 1. The detailed steps of the method for determining the scenario data of the self-driving car according to the embodiment of the disclosure are described below with the electronic device 100.

In step S210, the processor 120 may obtain training scenario data by using the scenario data, a loss function, and the self-driving program module 210. In detail, the processor 120 may execute the specific scenario data to obtain the training scenario data by using the self-driving program module 210. Furthermore, the processor 120 may obtain a loss value by using the loss function after the self-driving program module 210 executes the scenario data. The loss function may be preset by the processor 120 and/or stored in the storage medium 110, and may be used to evaluate whether the self-driving program module 210 may respond in real time when executing a specific scenario. For example, the loss function is generated by the processor 120 using methods such as deceleration, statistics of future collision probability according to past driving records, safety model data, or a combination of various values. The safety model is, for example, a responsibility-sensitive safety (RSS) model, but the disclosure is not limited thereto.

After the processor 120 executes the specific scenario data and obtains the loss value by using the self-driving program module 210, the processor 120 may determine “whether the scenario data is safe to the self-driving program module 210” (i.e., it is determined whether the self-driving program module 210 requires emergency braking from the self-driving car 200 when encountering this scenario data) by using the loss value and a preset loss value threshold. Furthermore, the processor 120 may use the loss value as training scenario data.

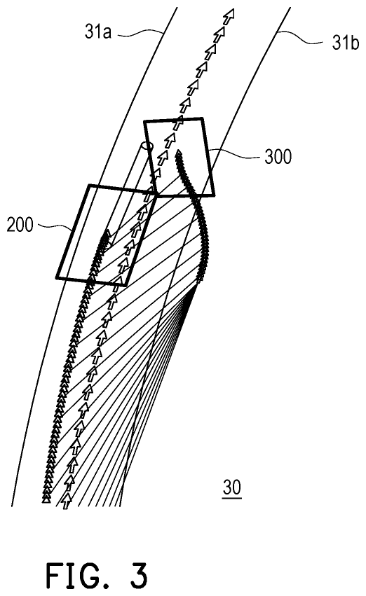

FIG. 3 is a schematic diagram of scenario data 30 according to an embodiment of the disclosure. Referring to FIG. 1 and FIG. 3 at the same time, as shown in FIG. 3, the scenario data 30 may include the trajectory and the planned travel route of the self-driving car 200 in the lane (i.e., between the lane line 31a and the lane line 31b), the trajectory of the test car 300, and the positional relationship between the self-driving car 200 and the test car 300 at different time points.

In an embodiment, the scenario data may include actual operation data of the self-driving car, traffic flow scenario, and parameterized model scenario. For example, the processor 120 may receive the previous actual operation data of the self-driving car 200 from the self-driving car 200 through the transceiver 130. For another example, the processor 120 may receive a traffic flow scenario and/or a parameterized model scenario generated by software simulation from an external server (not shown) through the transceiver 130. Parameterized model scenarios may include, but are not limited to, pedestrian charging out, rear car overtaking, and oncoming car making a U-turn.

The processor 120 may obtain the training scenario data by using the scenario data 30 shown in FIG. 3, the loss function, and the self-driving program module 210. In one embodiment, the training scenario data may include self-driving car speed, self-driving car trajectory, predicted self-driving car trajectory, images, point cloud data, weather, road geometry, traffic light status, and self-driving car sensor data. In addition, as described in the aforementioned embodiments, the processor 120 may use the loss value, obtained from executing the scenario data 30 by using the self-driving program module 210, as the training scenario data. The purpose of the training scenario data is subsequently described.

Returning to FIG. 2, in step S220, the processor 120 may train the encoding module 111 and the decoding module 112 by using the training scenario data, and generate a scenario space by using the trained encoding module 111.

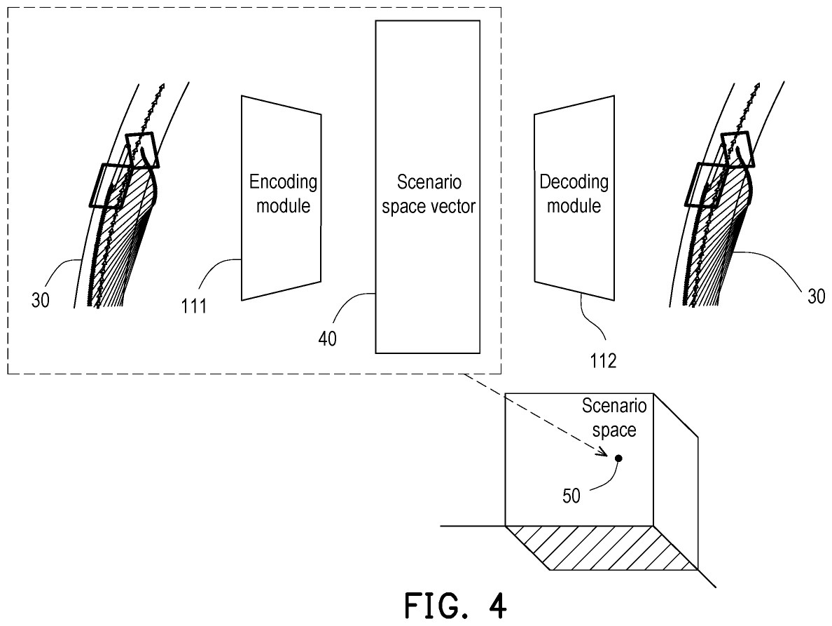

FIG. 4 is a schematic diagram of generating a scenario space according to an embodiment of the disclosure. Referring to FIG. 1, FIG. 3, and FIG. 4 at the same time, the processor 120 may encode the scenario data 30 by using the trained encoding module 111 to obtain the scenario space vector 40. Then, the processor 120 may construct the scenario space by using all the dimensions of the scenario space vector 40. That is, the scenario space is constructed by multiple scenario space vectors, and the scenario space vectors includes the scenario space vector 40. Furthermore, the point 50 corresponding to the scenario space vector 40 means the point where the “known” scenario data 30 is mapped to the scenario space. It should be noted here that although the scenario space in FIG. 4 and subsequent figures is represented by a 3-dimensional scenario space, the disclosure is not limited thereto.

Returning to FIG. 2, in step S230, the processor 120 may obtain the monitoring module by using the scenario space.

In detail, in addition to the scenario data 30 shown in FIG. 3, the processor 120 may also encode the aforementioned scenario data such as the actual operation data of the self-driving car, the traffic flow scenario, and the parameterized model scenario by using the trained encoding module 111, so as to map the scenario data to multiple points in the scenario space. Next, in order to find as much as possible the points that are “unknown” and “unsafe for the self-driving program module 210” from all the points in the scenario space, the processor 120 may find multiple first scenario space vectors from multiple scenario space vectors in the scenario space, in which the first scenario space vectors respectively correspond to multiple first scenario data, and a loss value of each of the first scenario data is greater than a loss value threshold. In other words, the multiple first scenario data mean the scenario data that are “unsafe for the self-driving program module 210”.

Specifically, in one embodiment, the processor 120 may obtain the first scenario space vectors of the scenario space vectors by using the trained decoding module 112, the scenario space vectors, the self-driving program module 210, and the loss function, in which the first scenario space vectors respectively correspond to multiple first scenario data. Furthermore, the processor 120 may decode each of the first scenario space vectors by using the trained decoding module 112 to obtain the first scenario data. Then, the processor 120 may obtain the loss value by using each of the first scenario data, the self-driving program module 210, and the loss function. This is further described below.

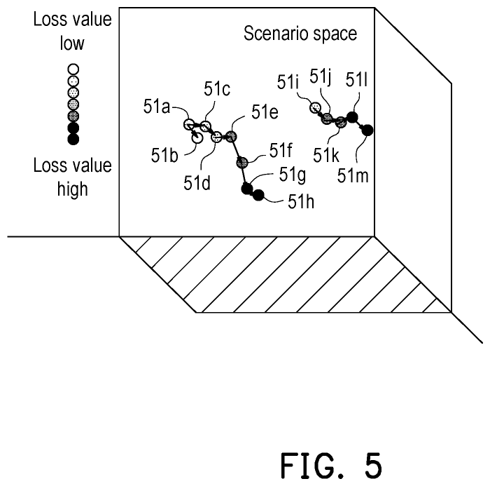

FIG. 5 is a schematic diagram of obtaining loss values of scenario data corresponding to points in the scenario space according to an embodiment of the disclosure. Referring to FIG. 1, FIG. 4, and FIG. 5 at the same time, in accordance with the aforementioned embodiments, in order to find as much as possible the points that are “unknown” and “unsafe for the self-driving program module 210” among all the points in the scenario space, the processor 120 may select a point 51a different from point 50 from all the points in the scenario space. Then, the processor 120 may decode the scenario space vector corresponding to the point 51a by using the trained decoding module 112 to obtain the scenario data corresponding to the point 51a. Then, the processor 120 may execute the scenario data corresponding to the point 51a by using the self-driving program module 210, and obtain the loss value of the scenario data corresponding to the point 51a by using the loss function.

Similarly, it is assumed that the processor 120 also executes the same operations as the aforementioned point 51a to the selected points 51b, 51c, 51d, 51e, 51f, 51g, 51h, 51i, 51j, 51k, 51l and point 51m that are different from point 50. In other words, the processor 120 may also obtain the loss value of the scenario data corresponding to the point 51b, the loss value of the scenario data corresponding to the point 51c . . . , and the loss value of the scenario data corresponding to the point 51m.

Next, the processor 120 may determine, among the scenario data corresponding to the point 51a, the scenario data corresponding to the point 51b . . . , and the scenario data corresponding to the point 51m, which scenario data have a loss value greater than the loss value threshold by using the loss value threshold. As shown in FIG. 5, if the loss value of the scenario data corresponding to the point 51g, the loss value of the scenario data corresponding to the point 51h, the loss value of the scenario data corresponding to the point 51l, and the loss value of the scenario data corresponding to the point 51m are greater than the loss value threshold, the processor 120 may determine that among all the points in the scenario space, the scenario data corresponding to the point 51g, the scenario data corresponding to the point 51h, the scenario data corresponding to the point 51l, and the scenario data corresponding to the point 51m are turning from “unknown” and “unsafe for the self-driving program module 210” to “known” and “unsafe for the self-driving program module 210”.

It should be noted that the disclosure does not limit the method for the processor 120 to select the point 51a, the point 51b . . . , and the point 51m. In one embodiment, the processor 120 may randomly select points 51a, 51b . . . , and point 51m from all the points in the scenario space to obtain the loss value of the scenario data corresponding to the point 51a, the loss value of the scenario data corresponding to the point 51b . . . , and the loss value of the scenario data corresponding to the point 51m. In another embodiment, the processor 120 may select points 51a, 51b, . . . , and point 51m from all the points in the scenario space by using statistical optimization/multiple iterations, so as to obtain the loss value of the scenario data corresponding to the point 51a, the loss value of the scenario data corresponding to the point 51b . . . , and the loss value of the scenario data corresponding to the point 51m.

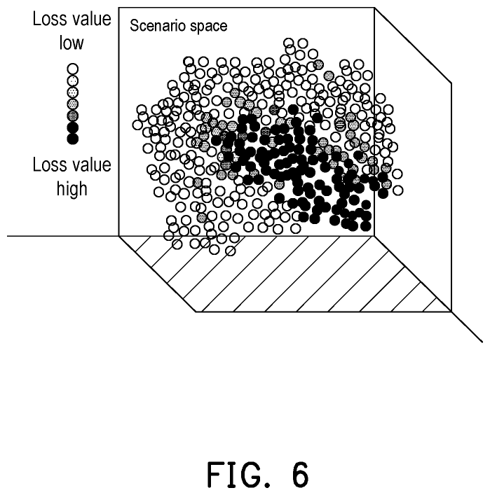

FIG. 6 is a schematic diagram of a monitoring module obtained based on the loss values according to an embodiment of the disclosure. Referring to FIG. 1, FIG. 4, FIG. 5, and FIG. 6 at the same time, in this embodiment, the processor 120 may obtain the monitoring module after searching the scenario space. This is further described below.

In an embodiment, in the aforementioned step S210, the training scenario data obtained by the processor 120 may include collision event occurrence data calculated by the processor 120 by using the Bellman equation. In the aforementioned step S220, the processor 120 may construct the trained encoding module 111 and the trained decoding module 112 by using the VectorNet encoding method combined with the VGAE architecture. Furthermore, in the aforementioned step S230, the processor 120 may obtain the loss value (the collision event occurrence data) of the scenario data corresponding to the point 51a, the loss value of the scenario data corresponding to the point 51b . . . , and the loss value of the scenario data corresponding to the point 51m by using the Bellman equation. Next, the processor 120 may use a genetic algorithm to find the local maximum value of these loss values, and then re-sample randomly. Furthermore, the processor 120 may use a Monte Carlo method to determine whether the aforementioned operation of searching the scenario space has been completed. After completing the aforementioned operation of searching the scenario space, the processor 120 may train a support vector regressor (SVR) by using the scenario data corresponding to the point 51a and its loss value, the scenario data corresponding to the point 51b and its loss value . . . , and the scenario data corresponding to the point 51m and its loss value to obtain the monitoring module.

It should be noted that after obtaining the monitoring module, if the processor 120 inputs a specific point in the scenario space (i.e., a specific vector in the scenario space) into the monitoring module, the processor 120 obtains the loss value of the specific point. The purpose of the monitoring module is further described below.

Returning to FIG. 2, in step S240, the processor 120 may execute the monitoring module to determine whether the current scenario data belongs to the operational design domain (ODD) by using the current scenario data and the trained encoding module.

In one embodiment, the processor 120 may receive the current scenario data of the self-driving car 200 in actual operation from the self-driving car 200 through the transceiver 130. Next, the processor 120 may encode the current scenario data by using the trained encoding module 111 to obtain the current scenario data space vector. Then, the processor 120 may execute the monitoring module by using the current scenario data space vector to obtain the current loss value. In other words, the processor 120 may input the current scenario data space vector into the monitoring module to obtain the current loss value. After obtaining the current loss value, the processor 120 may compare the current loss value with the loss value threshold. In response to determining that the current loss value is less than or equal to the loss value threshold, the processor 120 may determine that the current scenario data belongs to the operational design domain. In other words, the processor 120 may determine that the current scenario data is “safe for the self-driving program module 210”. On the other hand, if the processor 120 determines that the current loss value is greater than the loss value threshold, the processor 120 may determine that the current scenario data is “unsafe for the self-driving program module 210”.

Furthermore, when the processor 120 determines that the current scenario data is “unsafe for the self-driving program module 210”, the processor 120 may generate and provide recommended car speed and recommended turn. This is further described below.

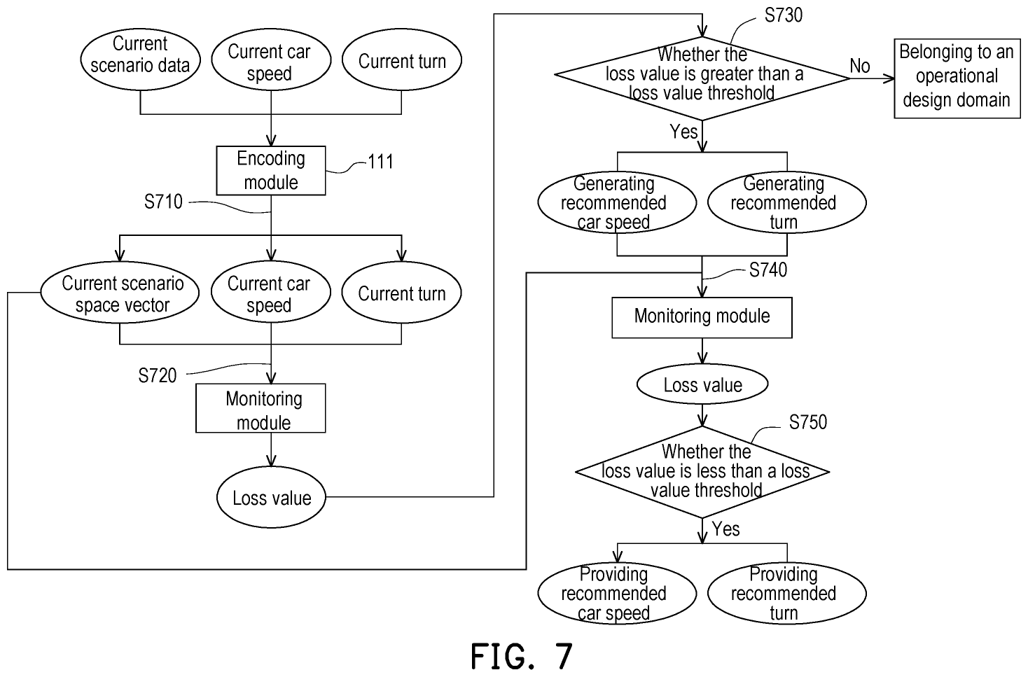

FIG. 7 is a flowchart of generating and providing recommended car speed and recommended turn according to an embodiment of the disclosure. Referring to FIG. 1, FIG. 4, FIG. 5, FIG. 6, and FIG. 7 at the same time, firstly, the processor 120 may receive the current scenario data, current car speed, and current turn of the self-driving car 200 of the self-driving car 200 in actual operation through the transceiver 130. It is assumed herein that the dimension of the scenario space is N-dimensional. Furthermore, each of the scenario space vectors may correspond to the car speed and the turn. In this embodiment, the processor 120 may execute the monitoring module to use the current scenario data, the current car speed, the current turn, and the trained encoding module 111 to determine whether the current scenario data, the current car speed, and current turn belong to the operational design domain.

In detail, in step S710, the processor 120 may encode the current scenario data, the current car speed, and the current turn by using the trained encoding module 111, so as to obtain the current scenario space vector in the scenario space (N−2 dimensional vector), the encoded current car speed (1 dimensional vector), and the encoded current turn (1 dimensional vector). In other words, the sum of dimensions of the current scenario space vector, the encoded current car speed, and the encoded current turn is still N-dimensional.

In step S720, the processor 120 may concatenate the current scenario space vector, the encoded current car speed, and the encoded current turn to obtain a specific point (specific N-dimensional vector) in the N-dimensional scenario space. Next, the processor 120 may input the concatenated current scenario space vector, encoded current car speed, and encoded current turn to the monitoring module to obtain the loss value of this specific point (specific N-dimensional vector).

In step S730, the processor 120 may determine whether the loss value is greater than a loss value threshold. If the loss value is less than or equal to the loss value threshold (the determination result of step S730 is “No”), the processor 120 may determine that the current scenario data, the current car speed, and the current turn belong to the operational design domain. In other words, the processor 120 may determine that the current scenario data, the current car speed, and the current turn are “safe for the self-driving program module 210”.

In one embodiment, in response to determining that the current scenario data, the current car speed, and the current turn do not belong to the operational design domain, the processor 120 may determine the recommended car speed and the recommended turn by using the scenario space.

In detail, if the loss value is greater than the loss value threshold (the determination result of step S730 is “Yes”), the processor 120 may determine that the current scenario data, the current car speed, and the current turn do not belong to the operational design domain. In other words, the processor 120 may determine that the current scenario data, the current car speed, and the current turn are “unsafe for the self-driving program module 210”. Then, the processor 120 may determine the encoded recommended car speed and the encoded recommended turn by using the scenario space. In detail, since each of the plurality of scenario space vectors in this embodiment may correspond to a car speed (1-dimensional vector) and a turn (1-dimensional vector), the processor 120 may find the encoded recommended car speed and the encoded recommended turn that are “safe for the self-driving program module 210” from the 2-dimensional scenario space formed by the car speed and the turn by using a method similar to that described in the aforementioned FIG. 5 and FIG. 6 and their embodiments.

In step S740, the processor 120 may concatenate the current scenario space vector, the encoded recommended car speed, and the encoded recommended turn to obtain a specific point (specific N-dimensional vector) in the N-dimensional scenario space. Next, the processor 120 may input the concatenated current scenario space vector, encoded recommended car speed, and encoded recommended turn to the monitoring module to obtain the loss value of this specific point.

In step S750, the processor 120 may determine whether the loss value is less than a loss value threshold. If the loss value is less than or equal to the loss value threshold (the determination result of step S750 is “Yes”), the processor 120 may provide a recommended car speed and a recommended turn to the self-driving program module 210 through the transceiver 130. In detail, the processor 120 may decode the encoded recommended car speed and the encoded recommended turn by using the trained decoding module 112 to obtain the recommended car speed and the recommended turn. Next, the processor 120 may provide the recommended car speed and the recommended turn to the self-driving program module 210 through the transceiver 130.

To sum up, the electronic device and the method for determining the scenario data of the self-driving car of the disclosure may train the encoding module and the decoding module by using the training scenario data and obtain the monitoring module, and then use the monitoring module to determine whether the current scenario data is safe for the self-driving car in actual operation. In addition, when it is determined that the current scenario data is unsafe, the recommended car speed and the recommended turn may also be provided to the self-driving car, thereby improving the safety and user experience of the self-driving car in actual operation.

Although the disclosure has been described in detail with reference to the above embodiments, they are not intended to limit the disclosure. Those skilled in the art should understand that it is possible to make changes and modifications without departing from the spirit and scope of the disclosure. Therefore, the protection scope of the disclosure shall be defined by the following claims.

What is claimed is:

1. An electronic device for determining scenario data of a self-driving car, comprising:
a storage medium, storing an encoding module and a decoding module; and
a processor, coupled to the storage medium and configured to:
obtain training scenario data by using the scenario data, a loss function, and a self-driving program module;
train an encoding module and a decoding module by using the training scenario data, and generate a scenario space by using a trained encoding module;
obtain a monitoring module by using the scenario space; and
execute the monitoring module to determine whether a current scenario data belongs to an operational design domain (ODD) by using the current scenario data and the trained encoding module.

2. The electronic device according to claim 1, wherein the scenario space comprises a plurality of scenario space vectors, wherein the processor is further configured to:
obtain a plurality of first scenario space vectors among the scenario space vectors by using a trained decoding module, the scenario space vectors, the self-driving program module, and the loss function, wherein the first scenario space vectors respectively correspond to a plurality of first scenario data, wherein a loss value of each of the first scenario data is greater than a loss value threshold.

3. The electronic device according to claim 2, wherein the processor is further configured to:
decode each of the first scenario space vectors by using the trained decoding module to obtain the first scenario data, and obtain the loss value by using each of the first scenario data, the self-driving program module, and the loss function.

4. The electronic device according to claim 1, wherein the processor is further configured to:
encode the current scenario data by using the trained encoding module to obtain a current scenario data space vector;
execute the monitoring module to obtain a current loss value by using the current scenario data space vector; and
in response to determining that the current loss value is less than or equal to a loss value threshold, determine that the current scenario data belongs to the operational design domain.

5. The electronic device according to claim 1, wherein the scenario space comprises a plurality of scenario space vectors, wherein each of the scenario space vectors corresponds to car speed and turn, wherein the processor is further configured to:
execute the monitoring module to determine whether the current scenario data, the current car speed, and the current turn belong to the operational design domain by using the current scenario data, the current car speed, the current turn, and the trained encoding module.

6. The electronic device according to claim 5, wherein the processor is further configured to:
in response to determining that the current scenario data, the current car speed, and the current turn do not belong to the operational design domain, determine a recommended car speed and a recommended turn by using the scenario space.

7. The electronic device according to claim 1, wherein the scenario data comprises actual operation data of the self-driving car, traffic flow scenario, and parameterized model scenario.

8. The electronic device according to claim 1, wherein the training scenario data comprises self-driving car speed, self-driving car trajectory, predicted self-driving car trajectory, images, point cloud data, weather, road geometry, traffic light status, and self-driving car sensor data.

9. A method for determining scenario data of a self-driving car, suitable for an electronic device storing an encoding module and a decoding module, the method comprising:
obtaining training scenario data by using the scenario data, a loss function, and a self-driving program module;
training an encoding module and a decoding module by using the training scenario data, and generating a scenario space by using a trained encoding module;
obtaining a monitoring module by using the scenario space; and
executing the monitoring module to determine whether a current scenario data belongs to an operational design domain by using the current scenario data and the trained encoding module.

10. The method according to claim 9, wherein the scenario space comprises a plurality of scenario space vectors, wherein obtaining the monitoring module by using the scenario space comprises:
obtaining a plurality of first scenario space vectors among the scenario space vectors by using the trained decoding module, the scenario space vectors, the self-driving program module, and the loss function, wherein the first scenario space vectors respectively correspond to a plurality of first scenario data, wherein a loss value of each of the first scenario data is greater than a loss value threshold.

11. The method according to claim 10, wherein obtaining the monitoring module by using the scenario space further comprises:
decoding each of the first scenario space vectors by using the trained decoding module to obtain the first scenario data, and obtaining the loss value by using each of the first scenario data, the self-driving program module, and the loss function.

12. The method according to claim 9, wherein executing the monitoring module to determine whether the current scenario data belongs to the operational design domain by using the current scenario data and the trained encoding module comprises:
encoding the current scenario data by using the trained encoding module to obtain a current scenario data space vector;
executing the monitoring module to obtain a current loss value by using the current scenario data space vector; and
in response to determining that the current loss value is less than or equal to a loss value threshold, determining that the current scenario data belongs to the operational design domain.

13. The method according to claim 9, wherein the scenario space comprises a plurality of scenario space vectors, wherein each of the scenario space vectors corresponds to car speed and turn, wherein executing the monitoring module to determine whether the current scenario data belongs to the operational design domain by using the current scenario data and the trained encoding module comprises:
executing the monitoring module to determine whether the current scenario data, the current car speed, and the current turn belong to the operational design domain by using the current scenario data, the current car speed, the current turn, and the trained encoding module.

14. The method according to claim 13, wherein executing the monitoring module to determine whether the current scenario data belongs to the operational design domain by using the current scenario data and the trained encoding module further comprises:
in response to determining that the current scenario data, the current car speed, and the current turn do not belong to the operational design domain, determining a recommended car speed and a recommended turn by using the scenario space.

15. The method according to claim 9, wherein the scenario data comprises actual operation data of the self-driving car, traffic flow scenario, and parameterized model scenario.

16. The method according to claim 9, wherein the training scenario data comprises self-driving car speed, self-driving car trajectory, predicted self-driving car trajectory, images, point cloud data, weather, road geometry, traffic light status, and self-driving car sensor data.
